(19) United States
(12) Patent Application Publication
(10) Pub. No.: US 2006/0146020 A1
(43) Pub. Date: Jul. 6, 2006

(54) Non-contact type coordinate measurement device

(76) Inventor: Hsin-Hung Tu, Hsin Chu City (TW)

Correspondence Address: HSIN-HUNG TU, NO. 151 HO PING RD., HSIN CHU CITY, TW

(21) Appl. No.: 11/082,764

(22) Filed: Mar. 18, 2005

(30) Foreign Application Priority Data
Dec. 31, 2004 (TW) 93221515

(51) Int. Cl. G09G 5/08

(52) U.S. Cl. 345/161

(57) ABSTRACT

A non-contact type coordinate measurement device includes a housing, a stick, an optical transmitting member and an image-sensing member. The housing has a supporting portion formed at a top thereof, and is closed and made of opaque materials. The stick is orientated to the housing via the supporting portion, and has an operation portion exposed out of the housing and a detection portion received in the housing. The optical transmitting member is arranged inside the housing. The image-sensing member is disposed on the detection portion of the stick for generating an image variation while the stick is manipulated.

### BACKGROUND OF THE INVENTION

1. Field of the Invention

The present invention relates to a non-contact type coordinate measurement device, and particularly relates to a non-contact type coordinate measurement device operated with a joystick.

2. Description of the Related Art

A joystick generally includes a housing for receiving electrical and mechanical components, a vertical shaft rotating within predetermined angles, and a plurality of sensors for detecting the displacements of the vertical shaft and converting these information into corresponding displacement signals.

In a variable resistor of a first conventional joystick, a resistance depends on a position contacted, and a delay time for charge depends on the resistance. Thus, how much the coordinate changes can be obtained. However, passive components, such as the variable resistor, are affected easily by environmental conditions, for example, temperature or moisture. The accuracy, stability and capacity of resolution of the displacement signals are conformably reduced. Every time, before the joystick is used, the variable resistor calibrated for zero output signals is processed, and this step is troublesome. In addition, the variable resistor is of the contact mechanical sensing type; contact on the variable resistor with great exertion over a long period of time results in abrasion and damages the variable resistor, and the accuracy of the output signal and service life thereof are influenced. Furthermore, the structure of the first conventional joystick needs a large space.

A second conventional joystick of the optical grating type includes at least sets of optical sensors (optical transmitters and optical receivers) to x and y coordinate axles and various structures of the photo interrupters. U.S. Pat. No. 6,181,327 B1 discloses two optical encoders used for detecting displacements of two guiding plates and generating corresponding displacement signals, and further discloses other elements with assembled complicated assembly. U.S. Pat. No. 6,597,453 B1 discloses four encoders relative to an annular photo interrupter. The annular photo interrupter has a plurality of holes for the light to transmit through, and the information detected from the four encoders can be compared, so that a precise displacement can be gained. But the quantity of the encoders is expensive.

### SUMMARY OF THE INVENTION

A non-contact type coordinate measurement device is provided with a simple structure like a joystick having an image-sensing member for detecting image variation and converting the information into coordinate signals. The non-contact type coordinate measurement device is simple in structure for sensitivity, high accuracy, and a long service life. It avoids the problems of abrasion and inaccuracy suffered by the contact-type joystick. By avoiding two sets of encoders used with an optical grating, and the present invention results in a simple, cheap design.

A non-contact type coordinate measurement device includes a housing, a stick, an optical transmitting member and an image-sensing member. The housing has a supporting portion formed at a top thereof, and is closed and made of opaque materials. The stick is orientated to the housing via the supporting portion, and has an operation portion exposed out of the housing and a detection portion received in the housing. The optical transmitting member is arranged inside the housing. The image-sensing member is disposed on the detection portion of the stick for generating an image variation while the stick is manipulated.

A non-contact type coordinate measurement device includes a housing, a stick and an image-sensing member. The housing is transparent to light, and has a supporting portion formed at a top thereof. The stick is orientated to the housing via the supporting portion, and has an operation portion exposed out of the housing and a detection portion received in the housing. The image-sensing member is disposed on the detection portion of the stick for generating an image variation while the stick is manipulated.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of an embodiment of a non-contact type coordinate measurement device according to the present invention;

FIG. 2 is a perspective view of another embodiment of the non-contact type coordinate measurement device applied with an optical transmitting member according to the present invention;

FIG. 3 is a perspective view of an embodiment of the non-contact type coordinate measurement device applied with an optical sensing member according to the present invention;

FIG. 4 is a perspective view of an embodiment of the non-contact type coordinate measurement device applied with a housing according to the present invention;

FIG. 5 is a perspective view of another embodiment of the non-contact type coordinate measurement device applied with the housing according to the present invention;

FIG. 6 is a perspective view of an embodiment of the non-contact type coordinate measurement device applied with a chambered pedestal according to the present invention;

FIG. 7 is a perspective view of an embodiment of the non-contact type coordinate measurement device applied with a limiting portion according to the present invention;

FIG. 8 is a perspective view of another embodiment of the non-contact type coordinate measurement device applied with the limiting portion according to the present invention;

FIG. 9 is a perspective view of another embodiment of the non-contact type coordinate measurement device according to the present invention;

FIG. 10 is a perspective view of a further embodiment of the non-contact type coordinate measurement device according to the present invention; and

FIG. 11 is a perspective view of a further embodiment of the non-contact type coordinate measurement device applied with the housing according to the present invention.

### DETAILED DESCRIPTION OF THE EMBODIMENTS

A non-contact type coordinate measurement device according to the present invention includes a stick used with an image-sensing member, so that the image-sensing member can detect the image variation of an object or a pattern. Furthermore, information of the image variation can be converted into X/Y coordinate signals via software (hardware). The advances of optical sensing technology can be put to use adequately in the field of joysticks. Non-contact optical sensing technology can prolong the service life thereof, and can be capable of high accuracy due to the simple structure. The non-contact type coordinate measurement device comprises a housing, a stick and an image-sensing member. The housing has a supporting portion arranged on a top thereof, and the configuration of the housing can be a bell or another structure equivalent thereto. The stick is orientated to the housing via the supporting portion, and has an operation portion exposed out of the housing and a detection portion received in the housing. The image-sensing member is disposed on the detection portion of the stick for generating an image variation while the stick is manipulated.

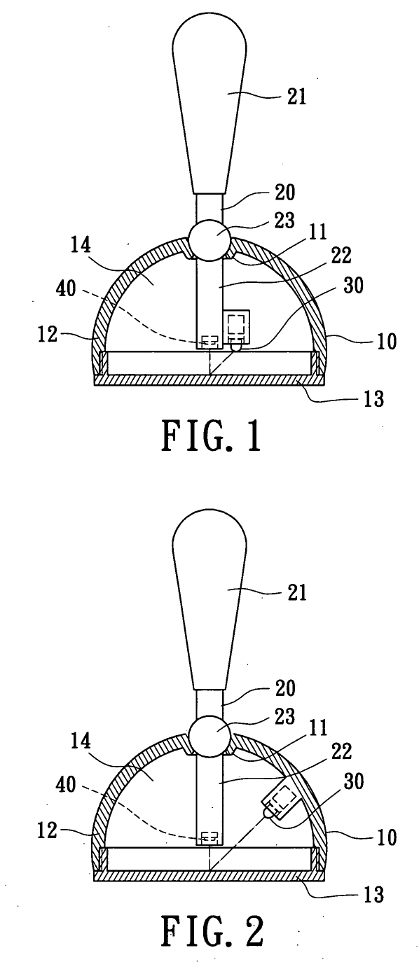

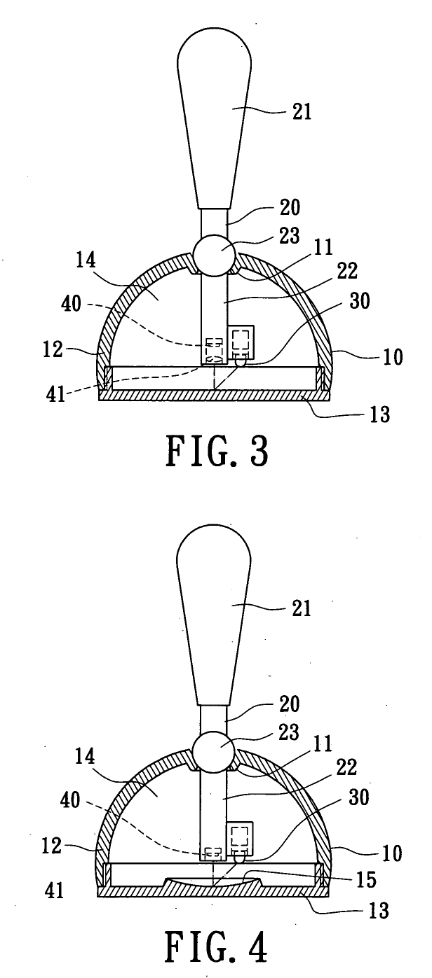

With respects to FIG. 1, a first embodiment of the non-contact type coordinate measurement device according to the present invention is illustrated. The non-contact type coordinate measurement device includes a housing 10, a stick 20, an optical transmitting member 30 and an image-sensing member 40. The housing 10 has a supporting portion 11 formed at a top thereof, and is closed and made of opaque materials. The stick 20 is orientated to the housing 10 via the supporting portion 11, and has an operation portion 21 exposed out of the housing 10 and a detection portion 22 received in the housing 10. The optical transmitting member 30 is arranged inside the housing 10. The image-sensing member 40 is disposed on the detection portion 21 of the stick 20 for generating an image variation while the stick 20 is manipulated. In this embodiment, the supporting portion 11 is formed by a recess concaved from the top of the housing 10 and a hole penetrating through the recess, and the stick 20 is attached to the housing 10 by the hole. The optical transmitting member 30 is disposed on the detection portion 22 of the stick 20, so as to move simultaneously in accordance with the image-sensing member 40 and to provide light required by the image-sensing member 40. The housing 10 includes at least one border shell 12, a bottom panel 13 connected with the border shell 12, and a receiving cavity 14 circumscribed by the border shell 12 and the bottom panel 13. The detection portion 22 of the stick 20 rotates or moves in the receiving cavity 14 about an orientation portion 23, which is connected between the operation portion 21 and the detection portion 23 thereof. The bottom panel 13 of the housing 10 has a natural picture or a recognizable predetermined pattern for defining a detected image. Referring to FIG. 2, the optical transmitting member 30 is disposed on the border shell 12 of the housing, and the image-sensing member 40 includes optical sensing components that can capture images, such as a charge-coupled device (CCD), a contact image sensor (CIS) or a complementary metal-oxide semiconductor (CMOS). The arrangement of the optical sensing components depends on the characteristics of the each optical sensing component. FIG. 3 illustrates the image-sensing member 40, including the charge-coupled device and a condensing lens 41 disposed on the detection portion 22 and under the charge-coupled device. In addition, the non-contact type coordinate measurement device can further includes an image comparison unit (not shown) to compare the posterior images with prior ones, signals corresponding the image variations will be gained, and the signals can be further output to a unit of equipment with an operation interface (not shown).

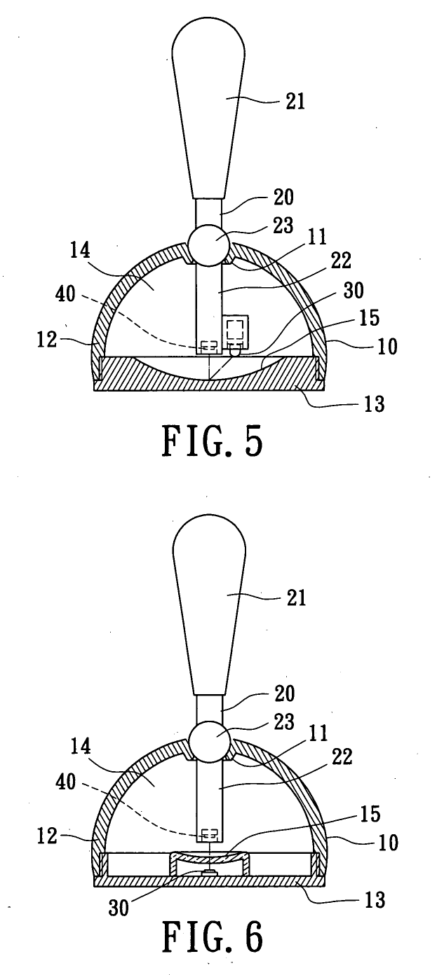

Because of the orientation manner of the detection portion 22 of the stick 20, a path the detection portion 22 catch locates on a predetermined curved surface. With respect to FIG. 4, the bottom panel 13 of the housing 10 includes a chambered pedestal 15 relative to the detection portion 22 of the stick 20. The chambered pedestal 15 is made of opaque materials in order to reflect lights from the optical transmitting member 30. The reason for arranging the chambered pedestal 15 is used to eliminate the phase difference that occurs if the bottom panel 13 has a flat surface thereon. Therefore, the chambered pedestal 15 is defined with a curved arc corresponding to the predetermined curved surface for sensing capacity with high accuracy. In addition, the chambered pedestal 15 has a natural picture or a recognizable predetermined pattern formed thereon for defining a detected image. Illustrated in FIG. 5, the bottom panel 13 of the housing 10 has a curved surface corresponding to the predetermined curved surface and relative to the detection portion 22 of the stick 20, so as to achieve an effect identical to that of the chambered pedestal 15. FIG. 6 shows the optical transmitting member 30 disposed beneath the chambered pedestal 15, which is made of transparent materials, so that a natural picture or the predetermined pattern can be projected and be detected.

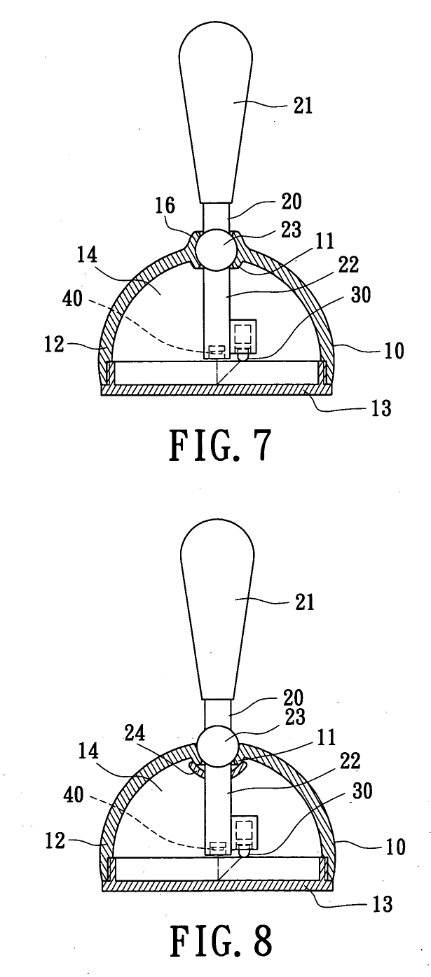

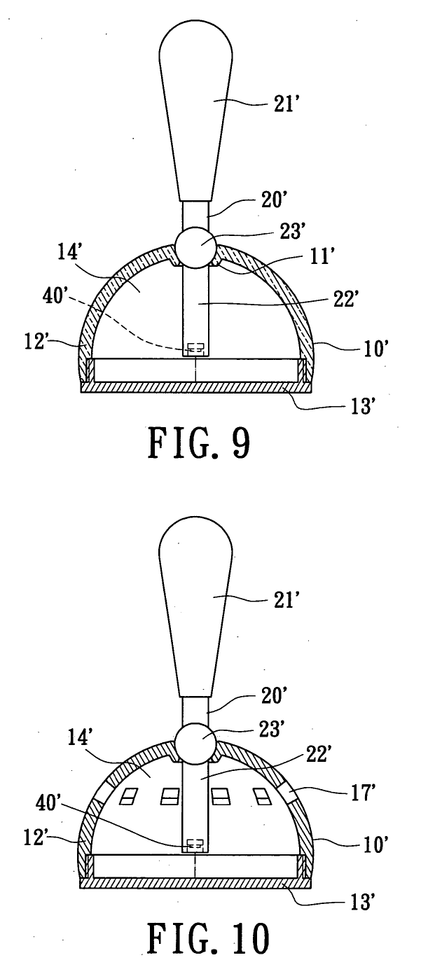

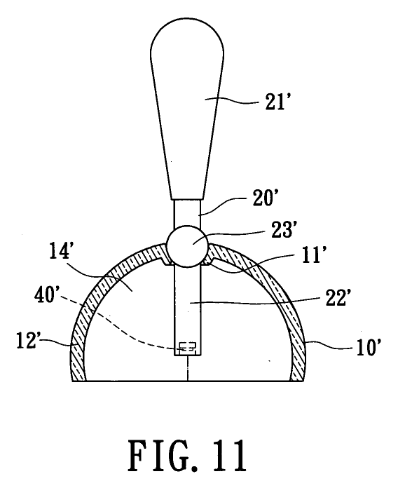

FIGS. 7 and 8 shows a limiting portion 24 of the stick 20 or a limiting portion 16 of the housing 10 further included in the non-contact type coordinate measurement device according to the present invention, so as to restrain and orientate the stick 30 to the supporting portion 11 of the housing 10. The limiting portion 16 extends from the supporting portion 11 upwards, and a cavity is formed by both the limiting portion 16 and the supporting portion for receiving the orientation portion 23, thus the orientation portion 23 restrained inside the cavity can rotate freely without departing from the housing 10. The limiting portion 24 of the housing 10 plays the same role as the limiting portion 16, and extends from detection portions 22 of the stick 20 outwards to clamp with the supporting portion 11 of the housing 10; thus the stick 20 can rotate freely without departing from the housing 110. Referring to FIG. 9, the non-contact type coordinate measurement device includes a housing 10′, a stick 20′ and an image-sensing member 40′. The housing 10′ is transparent to light, and has a supporting portion 11′ formed at a top thereof. The stick 20′ is orientated to the housing 10′ via the supporting portion 11′, and has an operation portion 21′ exposed out of the housing 10′ and a detection portion 22′ received in the housing 10′. The image-sensing member 40′ is disposed on the detection portion 22′ of the stick 20′ for generating an image variation while the stick 20′ is manipulated. The orientation manner of the stick 20′, and the arrangement of the image-sensing member 40′, can vary corresponding to embodiments mentioned above. The on-contact type coordinate measurement device can further include the limiting portion varied according to embodiments mentioned above. In this embodiment, the housing 10′ is made of transparent materials, and the image-sensing member 40′ can sense via the external light; the housing 10′ includes at least one border shell 12′, a bottom panel 13′ connected to the border shell 12′, and a receiving cavity 14′ circumscribed by the border shell 12′ and the bottom panel 13′. The detection portion 22′ of the stick 20′ rotates in the receiving cavity 14′ about the supporting portion 11′ of the housing 10′. Embodiments of the housing 10′, such as a flat surface of the bottom panel 13′, a chambered pedestal is added, the bottom panel 13′ has a curved arc corresponding to the predetermined curved surface, and a natural picture or a predetermined patterned formed thereon can be practiced in the manners mentioned above. FIG. 10 shows the housing 10′ made of opaque materials and having at least one slot 17′ formed thereon for external light getting in. The slot 17′ can be an elongated opening or composed with a plurality of slits, so that the external light can get in. FIG. 11 illustrates the housing 10′ in an open manner; for example, the bottom panel 13′ can be omitted due to ambient light and considerations regarding the configuration. In this case, the housing 10′ is equipped with the border shell 12′ without the bottom panel 13′ and is quite satisfactory in use.

According to the present invention, the advantages of the non-contact type coordinate measurement device are described as followed:

1. A simple structure like a joystick applied with an image-sensing member is provided for detecting image variation and converting the information into coordinate signals.

2. The simple structure is provided for sensitivity, high accuracy, and a long service life.

3. The non-contact type coordinate measurement device is provided to avoid the problems of abrasion and inaccuracy seen in contact-type joysticks.

4. The non-contact type coordinate measurement device is provided to avoid two sets of encoders applied with an optical grating, which are complicated and expensive.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A non-contact type coordinate measurement device, comprising:
a housing having a supporting portion formed at a top thereof, being closed and made of opaque materials;
a stick orientated to the housing via the supporting portion, and having an operation portion exposed out of the housing and a detection portion received in the housing;
an optical transmitting member arranged inside the housing; and
an image-sensing member disposed on the detection portion of the stick for generating an image variation while the stick is manipulated.

2. The device as claimed in claim 1, wherein the housing includes at least one border shell, a bottom panel connected with the border shell, and a receiving cavity circumscribed by the border shell and the bottom panel, and wherein the detection portion of the stick rotates in the receiving cavity about an orientation portion connected between the operation portion and the detection portion thereof.

3. The device as claimed in claim 2, wherein the bottom panel of the housing includes a chambered pedestal relative to the detection portion of the stick.

4. The device as claimed in claim 3, wherein the optical transmitting member is disposed on the housing and the stick in an alternating manner, and the chambered pedestal is made of opaque materials to reflect lights from the optical transmitting member.

5. The device as claimed in claim 4, wherein the chambered pedestal is made of transparent material, and the optical transmitting member is arranged beneath the chambered pedestal.

6. The device as claimed in claim 2, wherein the bottom panel of the housing has a flat surface or a curved surface relative to the detection portion of the stick.

7. The device as claimed in claim 2, wherein the bottom panel of the housing has a natural picture or a recognizable predetermined pattern.

8. The device as claimed in claim 1, wherein the optical transmitting member is disposed on the housing and the stick in an alternating manner.

9. The device as claimed in claim 1, further including a limiting portion arranged on the stick or the housing, so as to orientate the stick to the supporting portion of the housing.

10. The device as claimed in claim 1, wherein the image-sensing member includes a charge-coupled device (CCD), a contact image sensor (CIS) or a complementary metal-oxide semiconductor (CMOS).

11. The device as claimed in claim 10, wherein the image-sensing member includes the charge-coupled device, and a condensing lens disposed on the detection portion and under the charge-coupled device.

12. A non-contact type coordinate measurement device, comprising:
a housing, wherein the housing is transparent, and has a supporting portion formed at a top thereof;
a stick orientated to the housing via the supporting portion, wherein the stick includes an operation portion exposed out of the housing and a detection portion received in the housing; and
an image-sensing member disposed on the detection portion of the stick for generating an image variation while the stick is manipulated.

13. The device as claimed in claim 12, wherein the housing is made of transparent material.

14. The device as claimed in claim 12, wherein the housing is made of opaque material and has at least one slot formed therein to admit external light.

15. The device as claimed in claim 12, wherein the housing includes at least one border shell, and a receiving cavity circumscribed by the border shell, and wherein the detection portion of the stick rotates in the receiving cavity about an orientation portion between the operation portion and the detection portion thereof.

16. The device as claimed in claim 15, wherein the housing further has a bottom panel connected with the border shell.

17. The device as claimed in claim 16, wherein the bottom panel of the housing includes a chambered pedestal relative to the detection portion of the stick.

18. The device as claimed in claim 16, wherein the bottom panel of the housing has a flat surface or a curved surface relative to the detection portion of the stick.

19. The device as claimed in claim 16, wherein the bottom panel of the housing has a natural picture or a recognizable predetermined pattern.

20. The device as claimed in claim 12, further including a limiting portion arranged on the stick or the housing, so as to orientate the stick to the supporting portion of the housing.

21. The device as claimed in claim 12, wherein the image-sensing member includes a charge-coupled device (CCD), a contact image sensor (CIS) or a complementary metal-oxide semiconductor (CMOS).

22. The device as claimed in claim 21, wherein the image-sensing member includes the charge-coupled device, and a condensing lens disposed on the detection portion and under the charge-coupled device.
